(19) United States
(12) Patent Application Publication
(10) Pub. No.: US 2009/0291416 A1
(43) Pub. Date: Nov. 26, 2009

(54) DENTAL IMPRESSION MATRIX TRAY AND METHOD OF FABRICATION FOR TEMPORARY DENTAL PROSTHESES

(76) Inventor: Larry E. BRUNSON, Seabrook, TX (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/125,977

(22) Filed: May 23, 2008

(51) Int. Cl. A61C 9/00

(52) U.S. Cl. 433/215; 433/39

(57) ABSTRACT

A flexible dental impression tray for use with a curable matrix-forming material and a related method for fabricating temporary dental prostheses. The temporary matrix tray is configured to provide a moderate degree of flexibility and easy customization to a particular patient's dentition. Use of transparent material for the tray and the matrix material allow better visualization by the practitioner.

### TECHNICAL FIELD

The present invention relates generally to the field of dentistry, and more particularly to fabrication methods and impression trays for forming temporary dental prostheses such as crowns, bridges, or veneers.

### BACKGROUND OF THE INVENTION

When a dentist prepares teeth for laboratory-fabricated restorations, a temporary dental prosthesis of some type is typically utilized to protect the prepared tooth while the laboratory is fabricating the definitive or permanent restoration element. This “temporary” serves many purposes, including covering the prepared tooth, allowing for easy cleaning, holding the occlusion stable, and functioning similar to the definitive restoration or undamaged natural tooth, and generally needs to be anatomically congruent with the surrounding oral anatomy.

Various methods and equipment are used to fabricate temporaries. One common method of making a temporary crown is to make an impression of the tooth in an impression matrix before starting the restoration. The impression matrix can be formed, for example, from an elastomeric impression material, a quick set bite registration material, or an alginate impression material. After the tooth is prepared, typically by removal of a portion of the tooth, temporary forming material such as acrylic or bis-acryl composite is dosed into the impression matrix and placed over the prepared tooth to form the temporary. The temporary is cured and prepared, and then mounted on the prepared tooth using a temporary adhesive.

Generally, temporary impression matrixes are fabricated using an impression tray of the type utilized for making final impressions, typically a rigid full arch tray, a quadrant tray or a bite “triple tray”. Although the primary purpose of these trays is for making final impressions, they are also commonly utilized for making a temporary matrix. When making a final impression, a rigid tray is typically desirable. As a result, conventional wisdom in the field has been that a rigid tray is similarly desirable for making temporary impressions.

The use of a bite tray or “triple tray” is an alternative to the rigid tray, but generally requires the patient to bite back into the tray to fabricate the temporary. This is disadvantageous since the patient may have received a local anesthetic, and their proprioception is greatly reduced. Many times, using this technique results in an impression matrix being destroyed due to the patient biting down in an off center manner. These “triple trays” also typically have a mesh between the two opposing sides, and when used to make temporaries with a temporary matrix, the mesh often becomes incorporated in the temporary material, resulting in anatomy that is not congruent with a natural tooth. Also, techniques requiring the help of the patient cannot very well be employed if the patient is sedated.

Disposable metal temporary trays are also known. Many such trays include retention holes for holding the temporary impression matrix material in the tray, thereby making removal of the cured flexible matrix from the tray difficult. Known impression trays are typically a “one-size-fits-all” solution, and cannot easily be custom fit to a particular patient's unique dental structure. Many known impression trays are also undesirable in that their cost of manufacture, and subsequent cost to the dentist, is generally relatively high.

Thus it can be seen that needs exist for continuing improvement to methods and apparatus for preparing impressions for use in forming temporary dental prostheses. It is to the provision of methods and apparatus meeting these and other needs that the present invention is primarily directed.

### SUMMARY OF THE INVENTION

In example embodiments, the present invention provides improved methods and apparatus for preparing impressions for use in forming temporary dental prostheses. Despite the conventional wisdom among those skilled in the art that a rigid tray is desirable for making impressions for forming permanent dental prostheses, and so therefore is also desirable for making impressions for forming temporary dental prostheses, it has now been recognized that a rigid impression tray unnecessarily increases the force required to remove a temporary dental prosthesis from the impression matrix, which can cause distortion of the temporary when removing partially cured temporaries from the matrix. Accordingly, example forms of the invention include a temporary matrix tray having a composition and geometry that provides sufficient stiffness to force the elastomeric matrix material around the teeth sufficiently to capture the detailed anatomy, yet flexible enough to allow easy removal of the temporary from the matrix.

In further example embodiments, the temporary matrix tray of the present invention comprises a clear plastic shell used in combination with a clear elastomeric quick-set impression material to provide visibility for seating the matrix material. This type of impression matrix could also be used as a guide for tooth reduction in the restorative process. Representative forms of the matrix tray of the invention provide a relatively simple and inexpensive device as compared to the final impression trays previously used for fabricating temporaries. The temporary matrix tray of the present invention optionally also includes a flat marking surface receptive to marking with a permanent marker for identification.

The temporary matrix tray of the present invention is configured to effectively and efficiently form a temporary matrix. The size and shape of the temporary matrix tray is preferably configured to receive and capture an impression of the hard and soft tissues in the subject area, thus allowing a definitive seat for making the temporary. The tray is preferably made of clear plastic and is rigid enough to carry the unset impression material to the mouth and form it around the teeth, yet flexible enough to allow flexure of the set impression material and allow easy removal of the temporary. The material and construction of the temporary matrix tray preferably enable the tray to be easily cut with scissors or a lab knife, to permit chair-side customization to the patient's particular dental physiology.

A clear matrix tray can provide visibility to the surrounding dentition and, when used with a clear impression matrix material, will allow visual confirmation of seating while making the temporary. If used with a clear matrix material, the temporary matrix tray of the present invention can also allow visual inspection for adequate tooth reduction of the prepared tooth. In particular embodiments, the shell of the temporary matrix tray comprises a polypropylene molding approximately 0.030 inches thick. Example forms of the temporary matrix tray do not include a handle, and do not include holes or other features for matrix retention, whereby the cured matrix can optionally be removed easily from the tray if desired.

In one aspect, the present invention is a dental impression tray. The dental impression tray preferably includes a base plate, wherein at least a portion of the base plate has an arcuate section, and the base plate defines a generally planar writing surface for receiving identification data thereon. The dental impression tray preferably also includes a first flange extending from a first edge of the base plate, at least a portion of the first flange being curved to correspond to the arcuate section of the base plate, and the first flange having a free edge distal the base plate. The dental impression tray preferably also includes a second flange extending from a second edge of the base plate opposite the first edge, at least a portion of the second flange being curved to correspond to the arcuate section of the base plate, and the second flange includes a free edge distal the base plate. A channel is preferably defined between the first flange and the second flange for receiving a matrix-forming material for forming a dental impression and fabricating a temporary dental prosthesis therein. The base plate, the first flange and the second flange preferably include a resilient body that is sufficiently flexible to permit manipulation of a set matrix formed from the matrix-forming material within the channel for removal of the temporary dental prosthesis from the dental impression.

In another aspect, the invention is a dental impression tray. The dental impression tray preferably includes a base plate, a first flange extending from a first edge of the base plate, and a second flange extending from a second edge of the base plate opposite the first edge, whereby a channel is defined between the first flange and the second flange for receiving a matrix-forming material for forming a dental impression therein. The base plate, the first flange and the second flange preferably include a flexible and stiffly resilient unitary polymeric element having a material thickness of between about 0.010 to 0.050 inch.

In still another aspect, the invention is a method of forming a dental impression. The method preferably includes the steps of placement of a matrix-forming material within a flexible dental impression tray, pressing at least a portion of a patient's dentition into the matrix-forming material using the flexible dental impression tray, allowing the matrix-forming material to at least partially set, thereby forming a matrix defining an impression therein corresponding to the portion of the patient's dentition, and removing the flexible dental impression tray and the matrix from the patient's mouth.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a perspective view of a mandibular full arch embodiment of a temporary matrix tray according to an example form of the invention.

FIG. 2 is a perspective view of a mandibular anterior partial arch embodiment of a temporary matrix tray according to an example form of the invention.

FIG. 3 is a perspective view of a maxillary full arch embodiment of a temporary matrix tray according to an example form of the invention.

FIG. 4 is a perspective view of a maxillary anterior partial arch embodiment of a temporary matrix tray according to an example form of the invention.

FIG. 5 is a perspective view of a mandibular left/maxillary right partial arch embodiment of a temporary matrix tray according to an example form of the invention.

FIG. 6 is a perspective view of a mandibular right/maxillary left partial arch embodiment of a temporary matrix tray according to an example form of the invention.

FIG. 7 shows a mandibular full arch embodiment of a temporary matrix tray in-situ according to an example form of the invention.

FIG. 8 shows a mandibular anterior partial arch embodiment of a temporary matrix tray in-situ according to an example form of the invention.

FIG. 9 shows a maxillary full arch embodiment of a temporary matrix tray in-situ according to an example form of the invention.

FIG. 10 shows a maxillary anterior partial arch embodiment of a temporary matrix tray in-situ according to an example form of the invention.

FIG. 11a shows a mandibular left posterior partial arch embodiment of a temporary matrix tray in-situ according to an example form of the invention.

FIG. 11b shows a maxillary right posterior partial arch embodiment of a temporary matrix tray in-situ according to an example form of the invention.

FIG. 12a shows a mandibular right posterior partial arch embodiment of a temporary matrix tray in-situ according to an example form of the invention.

FIG. 12b shows a maxillary left posterior partial arch embodiment of a temporary matrix tray in-situ according to an example form of the invention.

FIG. 13 shows placement of matrix-forming material into a temporary matrix tray according to an example form of the invention.

FIG. 14 shows a dental impression formed within a cured matrix using a temporary matrix tray according to an example form of the invention.

FIG. 15 shows removal of the cured matrix from a temporary matrix tray according to an example form of the invention.

FIG. 16 shows a nested array of several temporary matrix trays according to an example form of the invention.

FIG. 17 shows user modification of a temporary matrix tray according to an example form of the invention.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

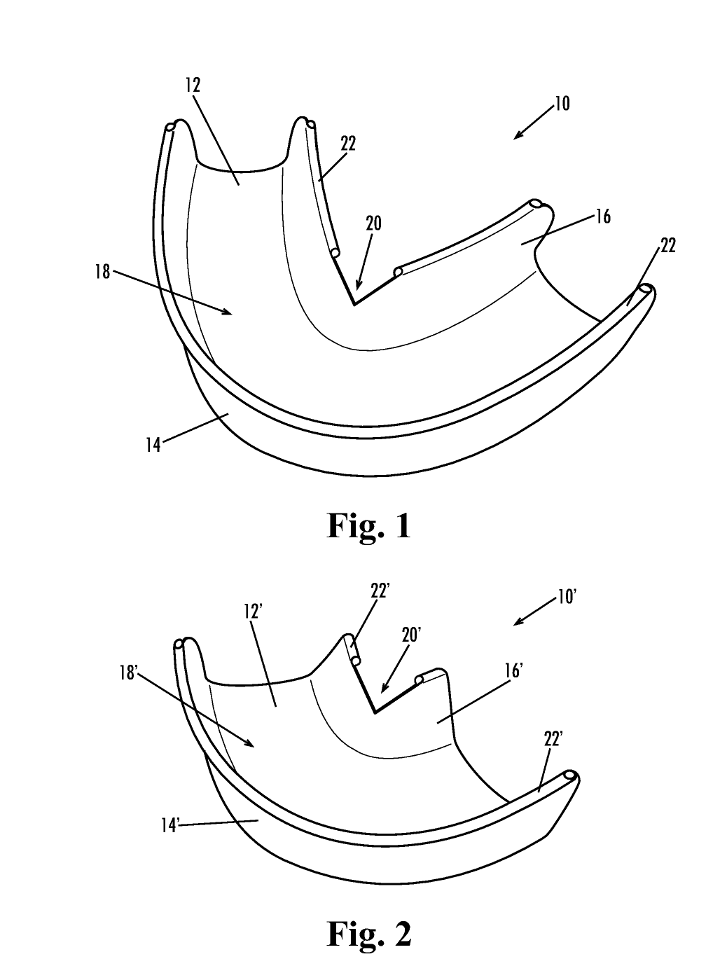

With reference now to the drawing figures, wherein like reference numbers represent corresponding parts throughout the several views, FIGS. 1-6 show a number of representative embodiments of temporary matrix trays according to example forms of the invention. These embodiments will give optimum tooth coverage for various impression areas throughout substantially the entire mouth, and allow a very accurate temporary matrix to be made for one tooth or for several teeth. Additionally, while the basic shapes and proportions will be similar, temporary matrix trays can be provided in a variety of sizes, for example, a first series of tray embodiments of a larger size range configured for use with adult patients, and a second series of tray embodiments of a smaller size range configured for use with child or adolescent patients.

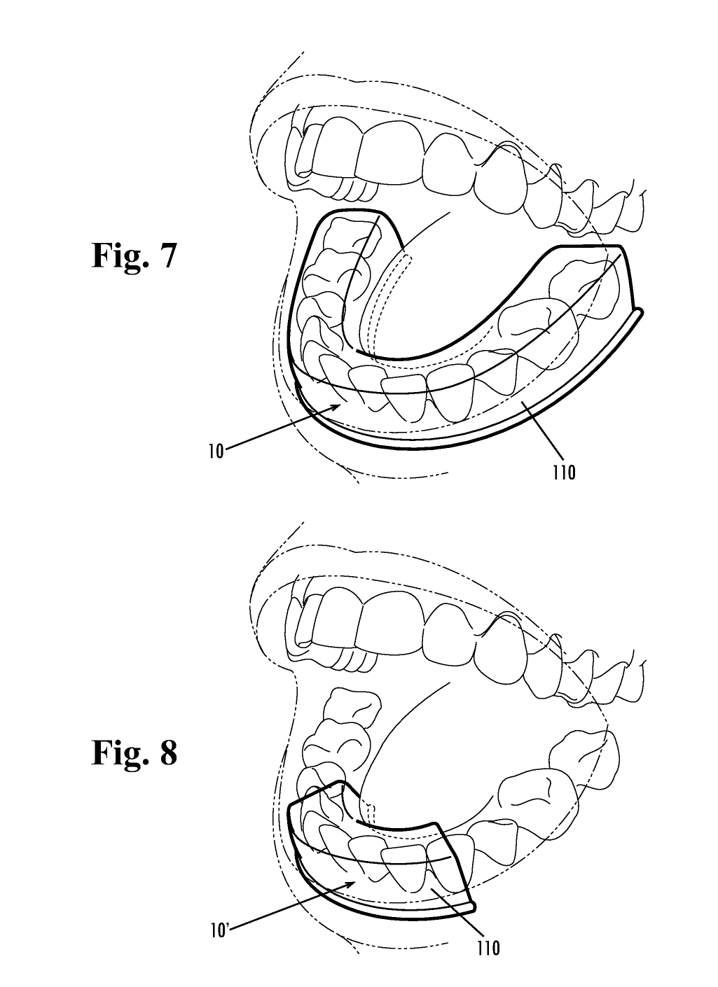

The temporary matrix tray 10 of FIG. 1 is a full mandibular arch embodiment for making an impression of all or a substantial portion of the teeth of the lower jaw. FIG. 7 shows tray 10 in place over the teeth of a patient, in an example manner of use. The temporary matrix tray 10 comprises an arcuate base plate 12, an anterior flange 14 extending from a first edge of the base plate, and a posterior flange 16 extending from a second edge of the base plate. The anterior flange 14 generally defines a first radius of curvature at a central or mesial portion thereof, and the posterior flange 16 defines a second radius of curvature at a central or mesial portion thereof that is smaller than the first radius of curvature. A first face of the base plate 12 and the confronting faces of the anterior flange 14 and the posterior flange 16 define an interior surface of the tray 10, which forms a curved concave channel or trough 18 for receiving matrix-forming material to form a dental impression therein. An opposed second face of the base plate 12 and the opposing faces of the anterior flange 14 and the posterior flange 16 define a curved convex exterior surface of the tray 10. The posterior flange 16 preferably has a section removed or omitted proximal its center at the distal or free edge thereof, forming a relief 20 for the patient's lingual frenum. The proximal edges of the anterior flange 14 and of the posterior flange 16 coincide with the anterior and posterior edges of the base plate, and form a corner or radius at their intersection. The distal or free edge(s) of the anterior flange 14 and/or of the posterior flange 16 are preferably rolled or flared to form an expanded or rounded edge contour 22. The full arch temporary matrix tray embodiments disclosed herein can be utilized in whole for making impressions of the patient's entire mandibular or maxillary dentition, or alternatively can be cut into sections by the practitioner and utilized in separate parts for making partial impressions of one or more teeth.

The temporary matrix tray 10′ of FIG. 2 is a partial anterior mandibular arch embodiment for making an impression of only a portion of the teeth of the lower jaw; for example, the mandibular anterior teeth and spanning from the mesial extent of the first molars on each side. The partial anterior mandibular temporary matrix tray 10′ is otherwise substantially similar to the full mandibular temporary matrix tray 10 described above, comprising an arcuate base plate 12′, an anterior flange 14′ extending from a first edge of the base plate, a posterior flange 16′ extending from a second edge of the base plate, and other like features designated with prime (′) reference numerals. FIG. 8 shows tray 10′ in place over the teeth of a patient, in an example manner of use.

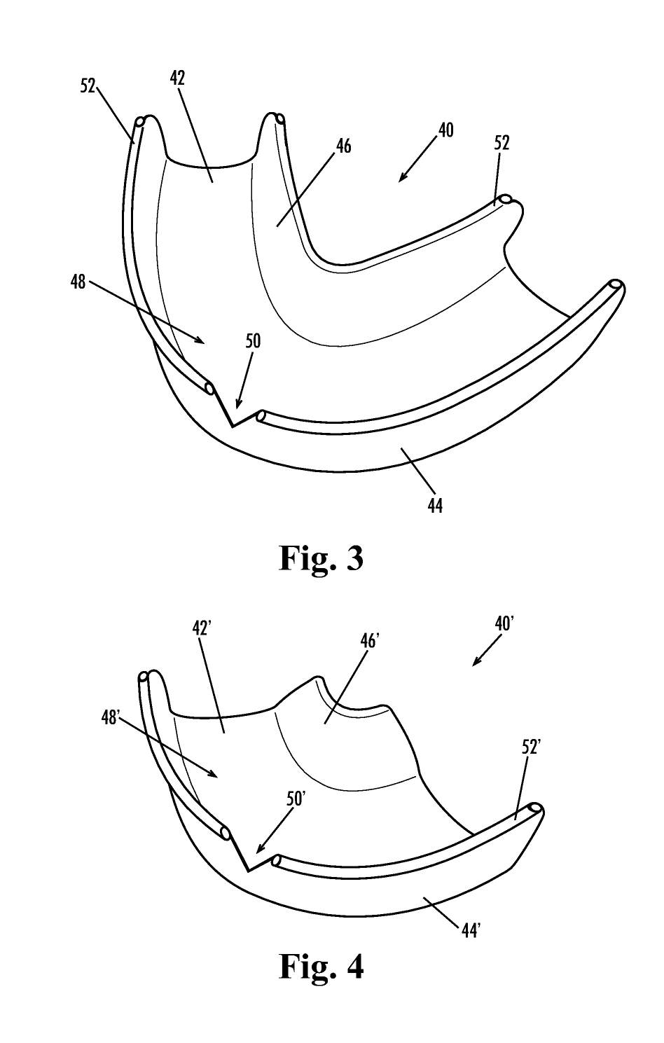

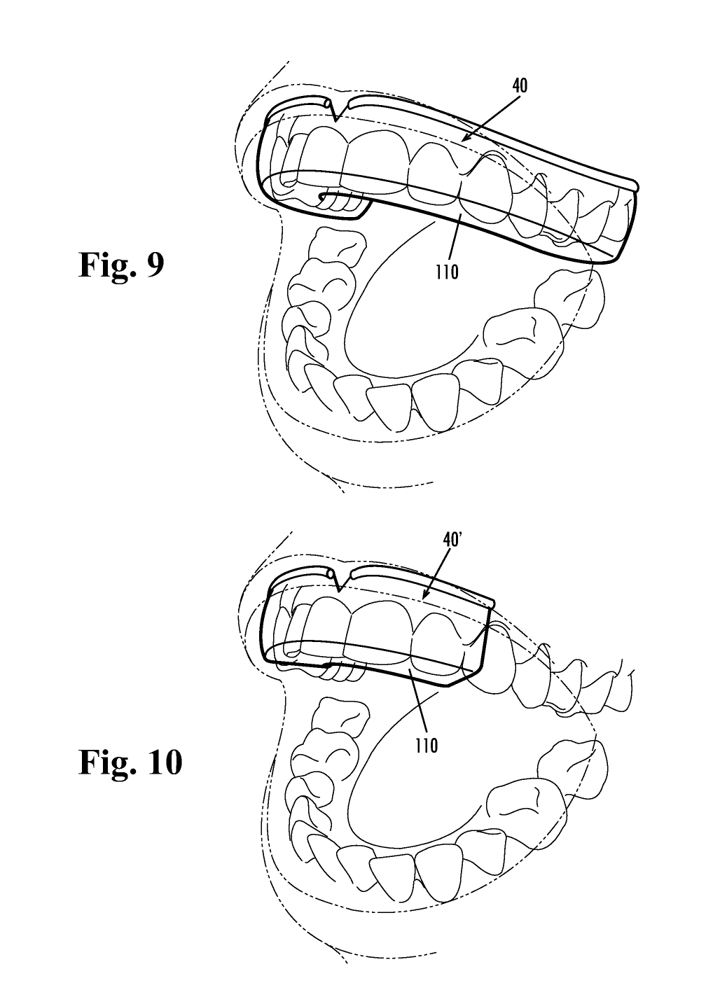

The temporary matrix tray 40 of FIG. 3 is a full maxillary arch embodiment for making an impression of all or a substantial portion of the teeth of the upper jaw. FIG. 9 shows tray 40 in place over the teeth of a patient, in an example manner of use. The temporary matrix tray 40 comprises an arcuate base plate 42, an anterior flange 44 extending from a first edge of the base plate, and a posterior flange 46 extending from a second edge of the base plate. The anterior flange 44 generally defines a first radius of curvature at a central or mesial portion thereof, and the posterior flange 46 defines a second radius of curvature at a central or mesial portion thereof that is smaller than the first radius of curvature. The posterior flange 46 preferably extends inwardly and upwardly from the base plate to provide partial coverage of the patient's anterior palate when placed over the teeth. A first face of the base plate 42 and the confronting faces of the anterior flange 44 and the posterior flange 46 define an interior surface of the tray 40, which forms a curved concave channel or trough 48 for receiving matrix-forming material to form a dental impression therein. An opposed second face of the base plate 42 and the opposing faces of the anterior flange 44 and the posterior flange 46 define an exterior convex curved surface of the tray 40. The anterior flange 44 preferably has a section removed or omitted proximal its center at the distal or free edge thereof, forming a relief 50 for the patient's labial frenum. The distal or free edge(s) of the anterior flange 44 and/or of the posterior flange 46 are preferably rolled or flared to form an expanded or rounded edge contour 52.

The temporary matrix tray 40′ of FIG. 4 is a partial anterior maxillary arch embodiment for making an impression of only a portion of the teeth of the upper jaw; for example, the maxillary anterior teeth and spanning from the mesial extent of the first molars on each side. The partial anterior maxillary temporary matrix tray 40′ is otherwise substantially similar to the full maxillary temporary matrix tray 40 described above, comprising an arcuate base plate 42′, an anterior flange 44′ extending from a first edge of the base plate, a posterior flange 46′ extending from a second edge of the base plate, and other like features designated with prime (′) reference numerals. FIG. 10 shows tray 40′ in place over the teeth of a patient, in an example manner of use.

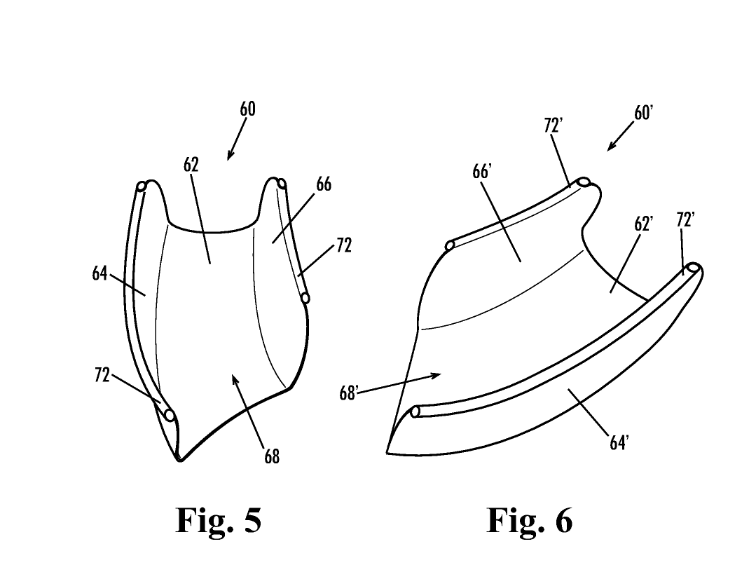

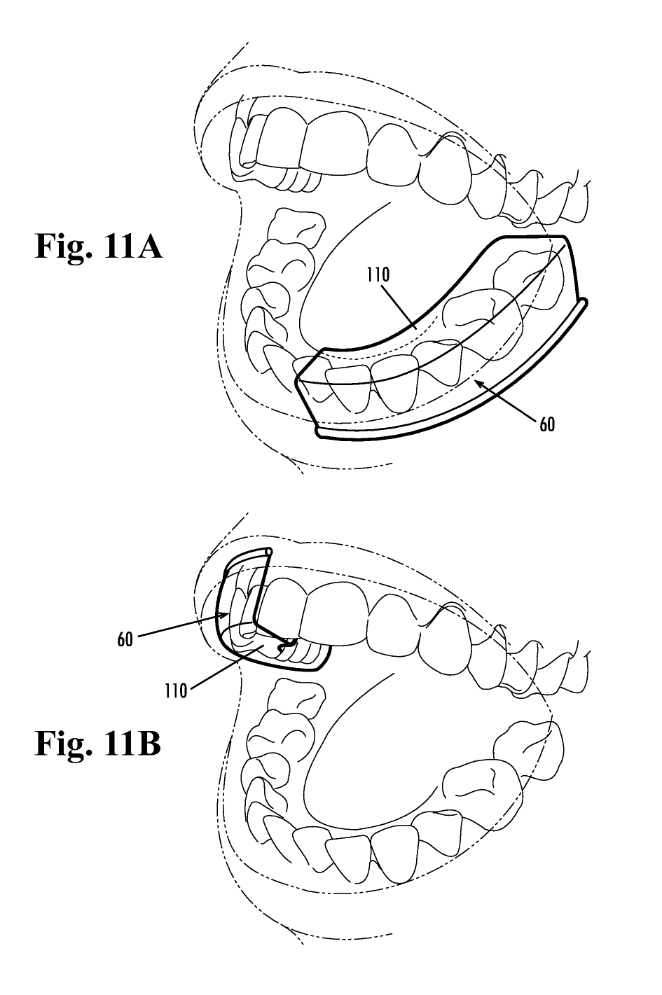

The temporary matrix tray 60 of FIG. 5 is a mandibular left/maxillary right posterior partial arch embodiment for making an impression of posterior teeth on the left side of the lower jaw and/or of posterior teeth on the right side of the upper jaw. FIGS. 11a and 11b show tray 60 in place over the teeth of a patient, on the mandibular left and maxillary right positions respectively, in example manners of use. In example forms, the tray 60 is sized and shaped to correspond to and cover all posterior teeth, and extending anteriorly to include the lateral incisors on the side of the impression being taken. In similar fashion to the embodiments described above, posterior partial tray 60 generally comprises a base plate 62, preferably having a greater degree of curvature at its anterior end than its posterior end, an exterior or buccal flange 64 extending from a first edge of the base plate, and an interior or lingual flange 66 extending from a second edge of the base plate, together forming a channel or trough 68 for receiving the impression matrix. The distal or free edge(s) of the exterior flange 64 and/or of the interior flange 66 are preferably rolled or flared to form an expanded or rounded edge contour 72.

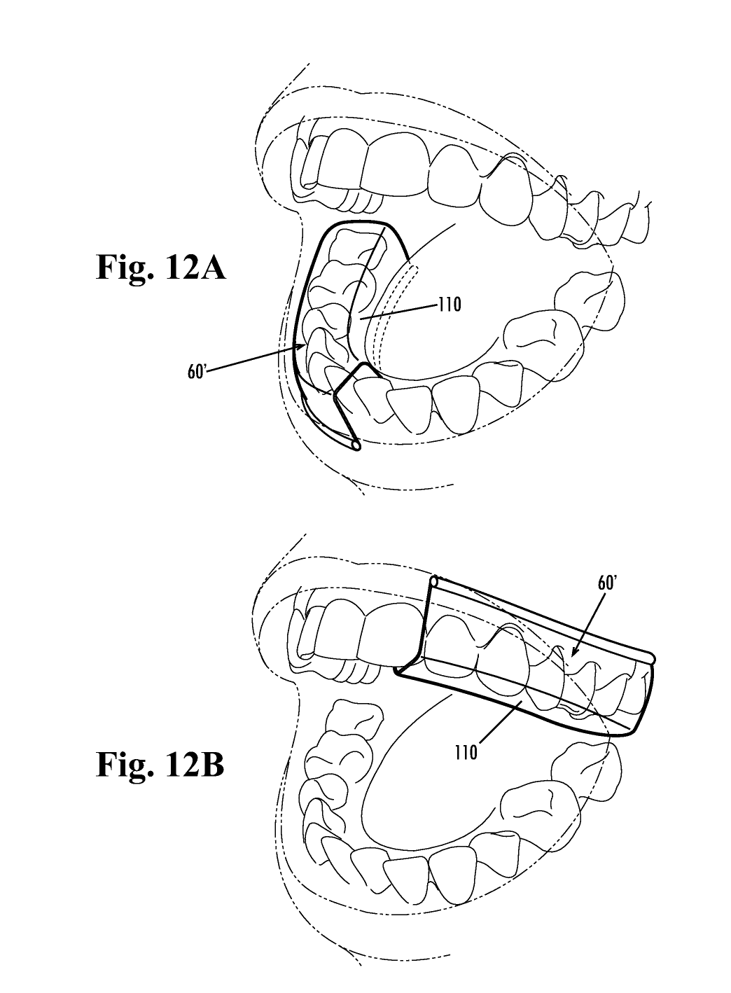

The temporary matrix tray 60′ of FIG. 6 is a mandibular right/maxillary left posterior partial arch embodiment for making an impression of posterior teeth on the right side of the lower jaw and/or of posterior teeth on the left side of the upper jaw. Temporary matrix tray 60′ is essentially a mirror image of the tray 60 of FIG. 5, with similar components indicated with a prime (′) symbol, including base plate 62′, exterior or buccal flange 64′, and interior or lingual flange 66′, defining channel or trough 68′, and having one or more rounded edge contour(s) 72′. FIGS. 12a and 12b show tray 60′ in place over the teeth of a patient, on the mandibular right and maxillary left positions respectively, in example manners of use.

The temporary matrix tray of the present invention, in each of its various embodiments disclosed herein, preferably comprises a composition and geometry that provides sufficient stiffness to force the elastomeric matrix material around the teeth and maintain it in place during curing sufficiently to capture a detailed impression of the anatomy, yet flexible enough to allow easy removal of the of the cured matrix from the teeth and easy removal of the temporary from the matrix. Using only light to moderate finger pressure, the practitioner may, for example, manipulate the set matrix within the tray in a manner sufficient to expand the impression in at least one dimension by at least about 1 mm or at least about 5% to assist in removal of the temporary from the matrix, and/or the flanges of the tray can be resiliently flexed at least about 2 mm apart from their unbiased position to assist in removal, without significant permanent deformation or damage to the tray or the set matrix. In example forms, this may be accomplished by forming the temporary matrix tray as a polypropylene (PP) molding having a material thickness of between about 0.010 to 0.050 inch, more preferably about 0.020 to 0.040 inch, and most preferably approximately 0.030 inch. In alternate embodiments, the temporary matrix tray may comprise other materials, including for example polyethylene (PE), high-density polyethylene (HDPE), polytetrafluoroethylene (PTFE), polycarbonate, acrylic, nylon, ABS, PVC, and/or other plastics or polymeric materials, alone or in combination. Preferably, the material of the temporary matrix tray is transparent or translucent, autoclavable or otherwise sterilizable, has a tensile strength in the range of 1500 to 10,000 pounds per square inch (psi), more preferably between 4000 to 6000 psi, and most preferably about 4500 psi, and a hardness in the range of SD55 to R120, more preferably between R75 to R110, and most preferably about R95. The material preferably resists fatigue failure sufficiently to permit repeated flexure without significant cracking or breaking.

The temporary matrix tray of the present invention is preferably fabricated by injection molding, blow molding, extrusion or other economically favorable fabrication methods. In example embodiments, the temporary matrix tray of the present invention includes no through-holes or other matrix-retentive aspects, no handle, and is configured to be easily and quickly modified by the dentist chair-side simply by using a pair of scissors or a lab knife. Further, example forms of the invention comprise a relatively planar or flat base plate portion having an exterior surface receptive to marking with a pen, pencil, marker or the like, to enable the practitioner to write the patient's name, the date, and/or other indicia thereon for identification or classification purposes. Optionally, the flat writing surface can be provided with a slightly roughened surface texture, a label, one or more pre-designated identifiers such as check-boxes or data fields, or otherwise be prepared for writing or marking thereon.

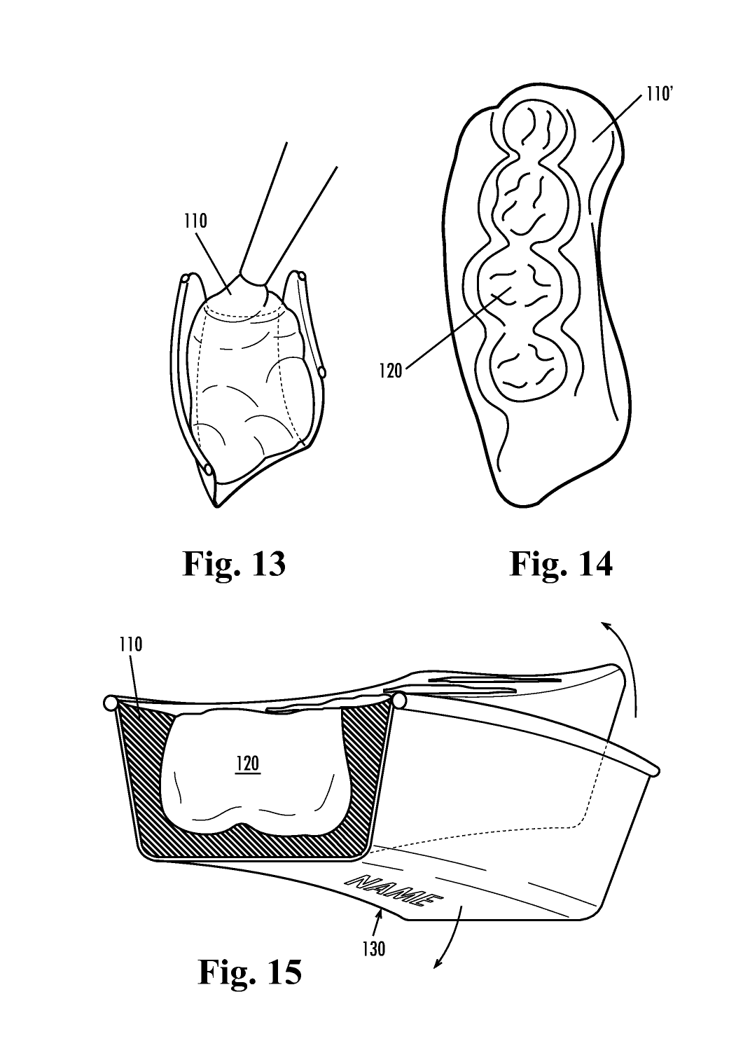

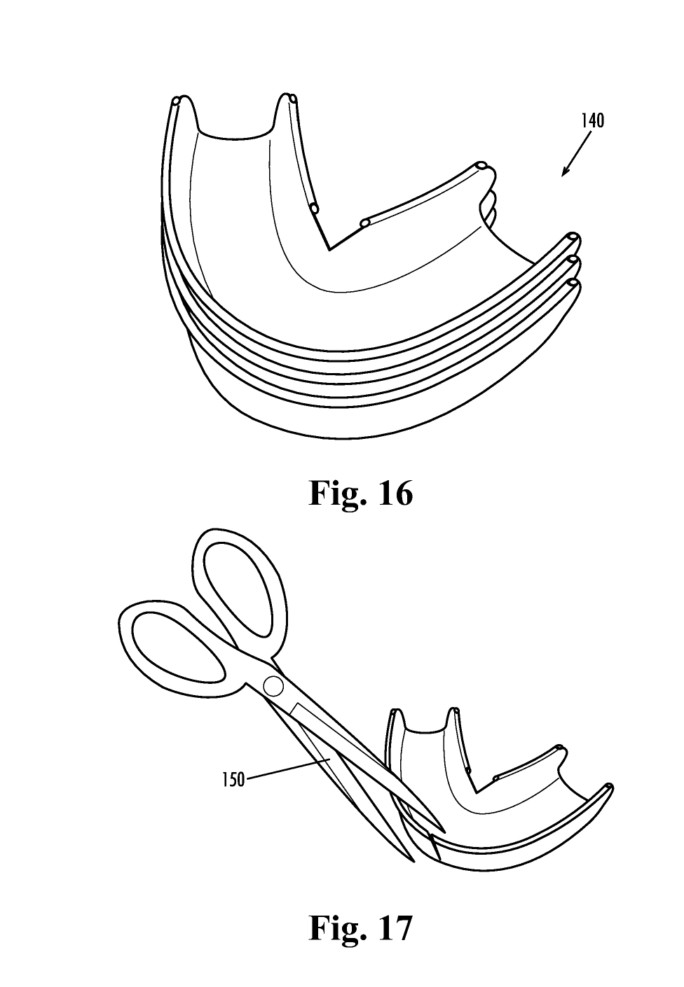

In an example method of use according to the present invention, the practitioner selects the appropriate type of temporary matrix tray for a given location in the mouth, for example by selecting one or more of the series of tray formats described above (e.g., full mandibular arch, full maxillary arch, partial anterior mandibular arch, partial anterior maxillary arch, mandibular left/maxillary right posterior partial arch, or mandibular right/maxillary left posterior partial arch) for placement over the subject area of dentition as shown for example in FIGS. 7-12. The dentist can try on the tray to test its fit over the subject dentition and, with transparent or translucent embodiments of the tray, will be able to better see if it needs to be modified, where, and to what extent. The temporary matrix tray will then be filled with the dentist's choice of matrix material 110, as shown in FIG. 13. In preferred form, the matrix material 110 will be a medium body, clear, fast-set, elastomeric impression material, but the use of other forms of matrix materials such as for example, alginate, elastomeric impression material, or bite registration material is within the scope of the invention. The temporary matrix tray will then be used to carry the impression matrix material 110 to the mouth and form it around the teeth in the area where the temporary will need to be made. The stiffness and resilience of the temporary matrix tray assists in compressing the matrix material 110 around and against the teeth and surrounding tissue to form a high-resolution impression. The dentist will hold the temporary matrix tray in place until the matrix material sets, and then the temporary matrix tray with the set matrix material 110′ will be removed. The procedure preferably captures an impression 120 of hard and soft tissue that will not be changed during the preparation of the teeth, as seen in FIGS. 14 and 15.

During tooth preparation, if the matrix material is clear, then the dentist will be able to replace the cured matrix 110′ onto the tooth and better judge the amount of tooth reduction by placing the matrix on the teeth and looking through the material. When ready to make the temporary, the dentist fills the appropriate area in the impression 120 formed within the matrix 110′ with their choice of temporary-forming material and reseats the tray and matrix onto the teeth. This will be easily done since the tray and matrix assembly will index on the unprepared teeth and the surrounding soft tissues. The dentist has the option of removing the tray-matrix assembly before the temporary is completely set or waiting until it is completely set. In either case the formed temporary will be easily removed from the tray-matrix assembly since the tray and matrix are flexible. Optionally, the tray can be separated from the matrix for easier manipulation of the matrix during removal, as shown in FIG. 15. Once the temporary is completed, the tray and matrix assembly can be easily identified by writing the patient's name, date of their appointment, and/or other data on the outside flat writing surface 130 of the tray, and can be stored according to typical fashion in the dental office. Storing the tray and matrix assembly while the patient is wearing the temporary advantageously allows another temporary to be easily and quickly fabricated should the temporary be broken or lost.

In example embodiments of the invention, the anterior and posterior flanges (or interior and exterior flanges) extend from the base plate of the temporary matrix tray at an obtuse angle, with the flanges inclined away from one another toward their distal edges, thereby allowing two or more trays to be nested or stacked within one another in a compact array 140, as seen in FIG. 16, for efficiency in shipping and storage.

While the various embodiments of the temporary matrix tray disclosed herein are generally envisioned to sufficiently fit any section of any mouth shape likely to be encountered, the temporary matrix tray of the present invention also readily permits user customization. As shown for example in FIG. 17, the practitioner can use a tool 150 such as scissors or a knife to easily cut or modify the temporary matrix tray chair-side using only light to moderate manual force, during a procedure, and thus accommodate any desired length or area of a patient's mouth.

While the invention has been described with reference to preferred and example embodiments, it will be understood by those skilled in the art that a variety of modifications, additions and deletions are within the scope of the invention, as defined by the following claims.

What is claimed is:

1. A dental impression tray comprising:
a base plate, wherein at least a portion of the base plate comprises an arcuate section, said base plate defining a generally planar writing surface for receiving identification data thereon;
a first flange extending from a first edge of the base plate, at least a portion of the first flange being curved to correspond to the arcuate section of the base plate, the first flange comprising a free edge distal the base plate;
a second flange extending from a second edge of the base plate opposite the first edge, at least a portion of the second flange being curved to correspond to the arcuate section of the base plate, the second flange comprising a free edge distal the base plate; and
a channel defined between the first flange and the second flange for receiving a matrix-forming material for forming a dental impression and fabricating a temporary dental prosthesis therein;
wherein the base plate, the first flange and the second flange comprise a resilient body that is sufficiently flexible to permit manipulation of a set matrix formed from the matrix-forming material within the channel for removal of the temporary dental prosthesis from the dental impression, but sufficiently stiff to compress the matrix-forming against subject dentition to form the dental impression.

2. The dental impression tray of claim 1, wherein the base plate, the first flange and the second flange comprise a polypropylene molding having a material thickness of between about 0.010 to 0.050 inch.

3. The dental impression tray of claim 1, wherein the base plate, the first flange and the second flange comprise a polypropylene molding having a material thickness of between about 0.020 to 0.040 inch.

4. The dental impression tray of claim 1, wherein the base plate, the first flange and the second flange comprise a polypropylene molding having a material thickness of approximately 0.030 inch.

5. The dental impression tray of claim 1, at least partially comprising a transparent material.

6. The dental impression tray of claim 1, wherein the free edges of the first and second flanges comprise a rounded edge contour.

7. The dental impression tray of claim 1, wherein at least one of the first and second flanges define a relief cutout portion.

8. The dental impression tray of claim 1, wherein the base plate, the first flange and the second flange do not include any matrix-retention features.

9. The dental impression tray of claim 1, wherein at least one of the base plate, the first flange and the second flange can be easily cut with scissors to customize the dental impression tray to a particular patient.

10. The dental impression tray of claim 1, wherein the set matrix is removable without obstruction from the channel.

11. The dental impression tray of claim 1, wherein the first flange and the second flange diverge outwardly from the base plate to permit nesting.

12. The dental impression tray of claim 1, comprising a full arch impression tray.

13. The dental impression tray of claim 1, comprising an anterior partial arch impression tray.

14. The dental impression tray of claim 1, comprising a posterior partial arch impression tray.

15. The dental impression tray of claim 1, wherein the base plate, the first flange and the second flange comprise a unitary integral molding.

16. A dental impression tray comprising:
a base plate;
a first flange extending from a first edge of the base plate;
a second flange extending from a second edge of the base plate opposite the first edge, whereby a channel is defined between the first flange and the second flange for receiving a matrix-forming material for forming a dental impression therein; and
wherein the base plate, the first flange and the second flange comprise a flexible and stiffly resilient unitary polymeric element having a material thickness of between about 0.010 to 0.050 inch.

17. The dental impression tray of claim 16, wherein the unitary polymeric element has a material thickness of between about 0.020 to 0.040 inch.

18. The dental impression tray of claim 16, wherein the unitary polymeric element comprises a polypropylene molding having a material thickness of approximately 0.030 inch.

19. The dental impression tray of claim 16, wherein the unitary polymeric element comprises polypropylene, polyethylene, high-density polyethylene, polytetrafluoroethylene, polycarbonate, acrylic, nylon, ABS or PVC.

20. The dental impression tray of claim 16, wherein the unitary polymeric element is transparent or translucent.

21. The dental impression tray of claim 16, wherein the unitary polymeric element has a tensile strength of between 1500 and 10,000 psi.

22. The dental impression tray of claim 16, wherein the unitary polymeric element has a tensile strength of between 4000 to 6000 psi.

23. The dental impression tray of claim 16, wherein the unitary polymeric element has a tensile strength of about 4500 psi.

24. The dental impression tray of claim 16, wherein the unitary polymeric element has a hardness of between SD55 to R120.

25. The dental impression tray of claim 16, wherein the unitary polymeric element has a hardness of between R75 to R110.

26. The dental impression tray of claim 16, wherein the unitary polymeric element has a hardness of about R95.

27. A method of forming a dental impression, said method comprising:
placement of a matrix-forming material within a flexible dental impression tray;
pressing at least a portion of a patient's dentition into the matrix-forming material using the flexible dental impression tray;
allowing the matrix-forming material to at least partially set, thereby forming a matrix defining an impression therein corresponding to the portion of the patient's dentition; and
removing the flexible dental impression tray and the matrix from the patient's mouth.

28. The method of claim 27, further comprising removing the matrix from the flexible dental impression tray.

29. The method of claim 27, further comprising fabricating a temporary dental prosthesis by delivering a temporary-forming material into the impression defined in the matrix and curing the temporary-forming material.

30. The method of claim 29, further comprising flexing the flexible dental impression tray to assist in removal of the temporary dental prosthesis from the matrix.

31. The method of claim 27, further comprising visually observing the patient's dentition through a transparent portion of the flexible dental impression tray.

32. The method of claim 27, further comprising customizing the flexible dental impression tray to the patient's dentition by cutting to remove a portion of the flexible dental impression tray.
